(19) United States
(12) Patent Application Publication
(10) Pub. No.: US 2003/0063757 A1
(43) Pub. Date: Apr. 3, 2003

(54) Acoustical speaker apparatus

(76) Inventor: Enrico Nojko Repouz, Los Angeles, CA (US)

Correspondence Address: STEVENS, DAVIS, MILLER & MOSHER, L.L.P., Suite 850, 1615 L Street, N.W., Washington, DC, 20036, US

(21) Appl. No.: 09/964,505

(22) Filed: Sep. 28, 2001

(51) Int. Cl. H04R 1/02; H04R 9/06

(52) U.S. Cl. 381/87; 381/336; 381/99

(57) ABSTRACT

A speaker apparatus having a first half and a second half, each having a rim and being generally paraboloid shaped, or bowl-shaped. A first opening, or window, is positioned near a vertex of the first half. A second opening is positioned near a vertex of the second half, and a grille positioned within the second opening. A mid-range component may be positioned within the first opening. When the apparatus is assembled, the respective rims of the first and second halves engage to form a generally hollow chamber therebetween.

### FIELD OF INVENTION

The invention is an acoustical speaker apparatus for amplifying and projecting sound.

### BACKGROUND OF INVENTION

Speakers are well known in the art. As electronic equipment becomes more advanced, speaker technology has also advanced. Differing methods and apparatuses have been devised to improve the resonance, sound quality, and clarity of speakers.

U.S. Pat. No. 3,802,533 to Brenden shows an acoustic lens suitable for use in holographic imaging methods and apparatus. Brenden '533 shows a pair of thin membranes prestretched across a frame to form a cavity that is filled with a sound refracting fluid.

U.S. Pat. No. 5,068,836 to Steel shows a flextensional sonar transducer having a first cavity defined by an elliptical shell and end plates covering the two ends of the shell, and a vibration drive means coupled to the shell inside the cavity. Another cavity is connected to the first cavity. Steel also shows an opening between the two cavities for coupling the two cavities for the further cavity to affect the resonant frequency of the first.

### SUMMARY OF THE INVENTION

The invention is a speaker apparatus having a first half having a rim, and a second half with a rim. The halves are generally paraboloid shaped, or bowl-shaped. A first opening, or window, is positioned near a vertex of the first half; it may be generally concentric with the rim. The apparatus further includes a second opening positioned near a vertex of the second half, and a grille positioned within the second opening. A mid-range component may be positioned within the first opening.

At least one tweeter, and at least one cross-over component are each coupled to the grille. When the apparatus is assembled, the respective rims of the first and second halves engage to form a generally hollow chamber therebetween. The apparatus may also include a lock on the rim of at least one of the halves configured to keep the halves together.

The apparatus may also include a stand coupled to an outer surface of one of the first or second halves, and, wherein the rims and stand both engage a horizontal surface when the apparatus. In order to accomplish this end, the stand may be coupled to the outer surface generally adjacent the rims, and positioned generally parallel, or nearly parallel, to a tangent of the rims. In a preferred embodiment, the stand is coupled to the apparatus near the first end of the stand, and a node is positioned near the first end. The node is configured to cooperate with the stand and the rims-in order to provide a base for the apparatus when placed on a horizontal surface.

The speaker apparatus may also include an actuator (such as a switch, for example) in communication with the at least one tweeter and the at least one cross-over component. The actuator may include at least one of volume controls, bass control, or treble control, or it may even include a graphic equalizer.

In a preferred embodiment of the apparatus, the halves are metal. Additionally, a vibration damper may be positioned between an edge the mid-range component and an edge of the first opening. Similarly, a vibration damper may be positioned between an edge of the grille and an edge of the second opening.

The speaker may require a power source, such as a battery or an electrical outlet. In the event an electrical outlet is used as a power source, the apparatus may include a plug or receptacle on an outer surface.

Each of the openings—namely the window for the mid-range component, and the opening for the grille—may be round or circular. Of course, other configurations are possible. In one preferred embodiment, the second opening is smaller than the first opening.

In a preferred embodiment, the electronics on the grille, such as the tweeter(s), cross-over component(s), and/or the woofer(s) are aimed toward the hollow chamber. Additionally, the mid-range component is pointed outward, and away from the hollow chamber.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of the apparatus, according to the principles of the invention.

FIG. 2 is an exploded view of the apparatus, according to the principles of the invention.

FIG. 3 is a front view of the apparatus.

FIG. 4 is a rear view of the apparatus.

FIG. 5 is a plan view of the first half.

FIG. 6 is a plan view of the second half.

FIG. 7 is a plan view of the grille.

FIG. 8 is a detailed side view of the lock holding the halves together.

### DETAILED DESCRIPTION OF PREFERRED EMBODIMENTS

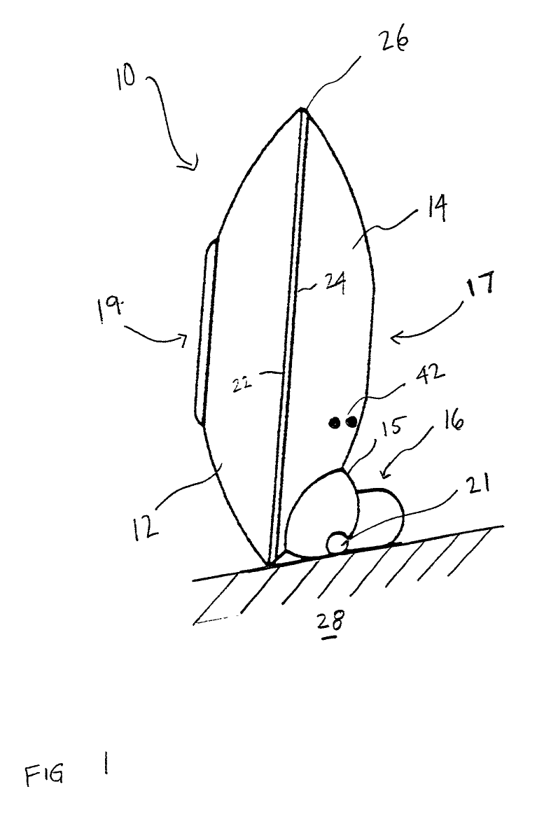

Referring to FIG. 1, the apparatus 10 includes a first half 12 and a second half 14. Each of the halves 12, 14 are general paraboloid, or bowl-shaped. The halves 12, 14 each terminate in rims that engage one another to from a perimeter 26. As shown in FIG. 1, the perimeter 26 and stand 16 cooperate to support the apparatus 10 on a surface 28.

The stand 16 is shown coupled to the second half 14, but it may be coupled to the first half 12 as well. The stand 16 includes a first end 15 coupled to the second half 14. A node 21 protrudes from the first end 15 of the stand 16. In this preferred embodiment, the node 21 engages the surface 28 and assists in providing a stable base for the apparatus 10.

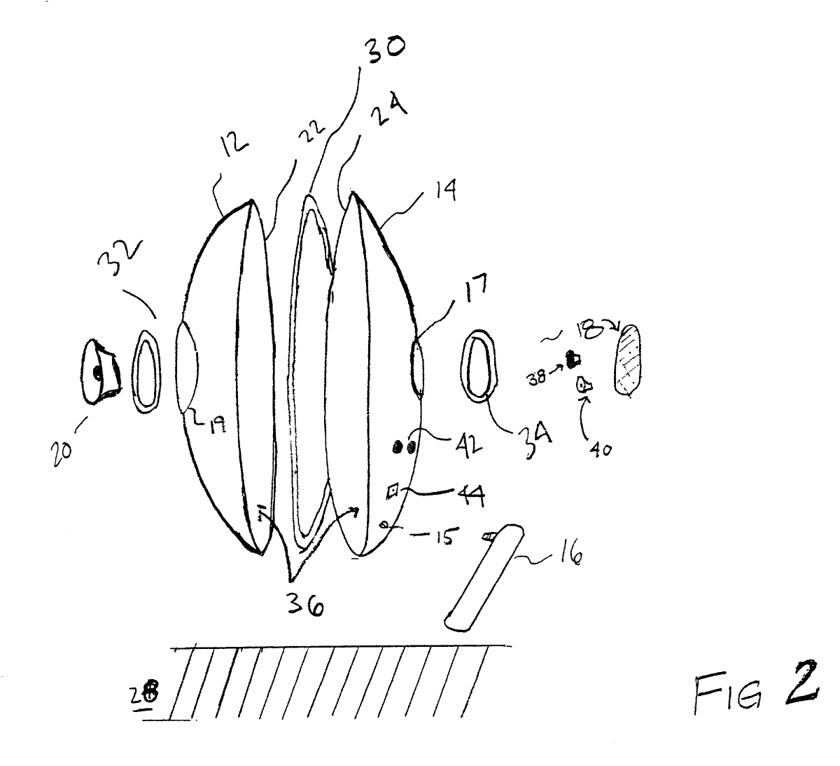

FIG. 2 shows an exploded view of the apparatus 10 that affords greater detail of the parts of the invention. The first half 12 has a rim 22, and the second half has a rim 24. The rims 22,24 are configured to tightly engage one another in order to from the perimeter 26 (which is shown in FIG. 1). Additionally, each of the rims may be equipped with a lock, discussed in greater detail hereinafter (and shown in FIG. 8), in order to hold the halves 12,14 together.

A vibration damper 30 may be positioned between the halves 12, 14 as well. As shown in FIG. 2, the damper 30 bears the shape and configuration of an o-ring or washer; however, any other configuration, such as a plurality of discrete pads, or even a sheet-type pad. Additionally, the halves 12, 14, when joined at their respective rims 22,24 from a generally hollow chamber 36 between the halves 12, 14.

The first half 12 has a window 19 formed to receive a mid-range component 20. The window is shown to be generally centrally positioned, near a vertex of the paraboloid shape of the half 12. However, the window may be positioned elsewhere on the half 12, and may be any suitable shape, such as round, square, elliptical, or polygonal. In order to prevent extraneous noise from vibration, a damper 32 may be positioned between the edge of the mid-range component 20 and the window 19. The damper 32 is shown to be an o-ring or washer-type damper, but any known type of resilient, damper material would suffice. The mid-range component 20 may be attached to the window by any known method, such as by screws, or by snap-fitting, for example.

As shown in FIG. 2, the second half has an opening 17 formed to receive a grille 18. The grille 18 bears the electronics, such as the tweeters 38, cross-over components 40, or woofers (not shown). A vibration damper 34 may be positioned between the edge of the grille 18 and the edge of the opening 17 in order to prevent interfering vibrations. Of course, the grille 18 may be installed into the opening 17 using any known method, as discussed above with respect to the installation of the mid-range component 20 into the window 19.

FIG. 2 shows the stand 16 coupled to the second half 14; alternatively, the stand 16 may be coupled to the first half 12. In a preferred embodiment, the stand 16 is coupled to the half 12 or 14 at a location near the perimeter 26. In this embodiment, the stand 16 is positioned to extend in a plane that is substantially parallel, or nearly parallel, to a plane tangent to the perimeter 26. It has been found that this configuration—with the stand 16 generally parallel to a tangent plane—provides a stable apparatus 10. In order to attach the stand 16 to the second half 14, a hole 15 is provided near the rim 24 in order to receive a fastener, such as a bolt, to couple the stand to the second half 14.

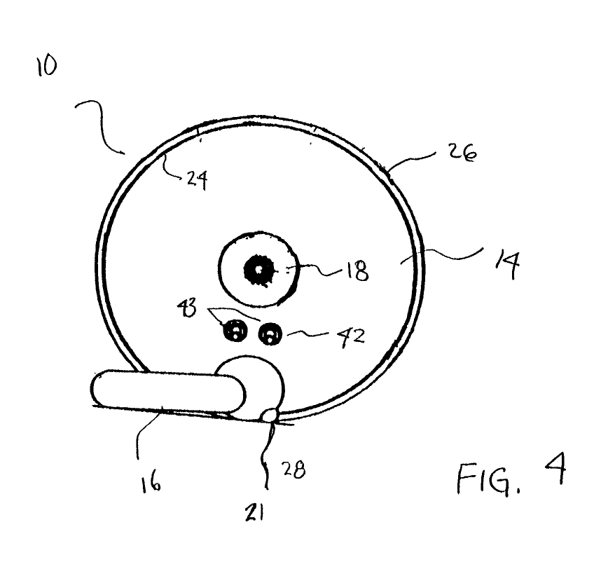

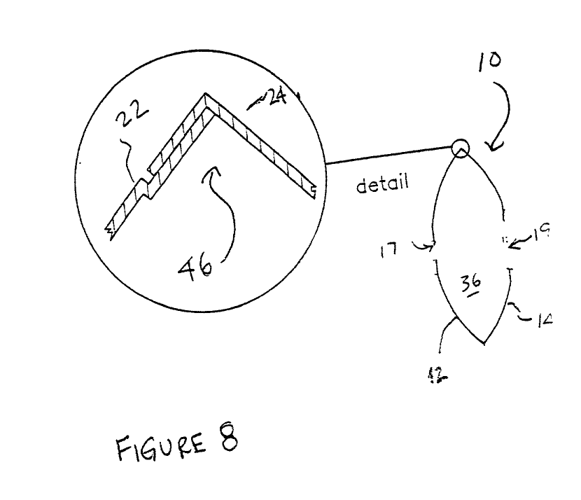

As shown in FIG. 2, the second half 14 may also have an actuator 42, such as knobs or a switch, to control the sound output of the apparatus 10. The actuator 42 may include volume controls, bass or treble level controls, or even a graphic equalizer. -The actuator 42 may include grommets 43 (shown in FIG. 4) having vibration dampers. Also, in order to provide power, the apparatus 10 should include a power source, such as an electrical receptacle 44 on the second half 14 in communication with the grille 18, and the electronics thereon. As is common, the electronics (such as tweeters 38 and cross-over components 40, discussed hereinafter) on the grille may be operated by a separate low-voltage power source, such as a battery 42 (shown in FIG. 7).

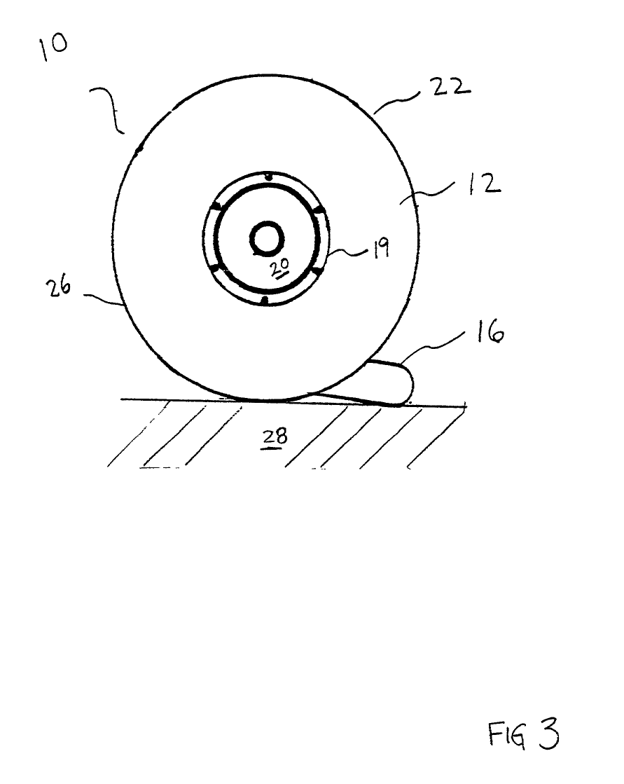

FIGS. 3 and 4 show comparative views of the apparatus 10. FIG. 3, for example, shows a front view of the apparatus 10, and details the positioning of the grille 20 in a preferred, centrally-located position on the first half 12 is depicted. Additionally, the stand 16 is shown to be generally parallel to the surface 28.

FIG. 4 shows the rear view of the apparatus 10, with the grille 18 in a preferred, centrally-located position on the second half 14. The actuators 42 are configured on the second half 14, and may have grommets 43 positioned between the surface of the half 14 and the actuators 42 in order to prevent rattling or vibration.

As shown in FIG. 4, the stand 16 is coupled to an outer surface of the second half near the rim 24, and positioned nearly parallel to the surface 28 and a plane tangent to the perimeter 26. The stand 16 is coupled to the half 14 in any known means, such as a screw, bolt, or other fasteners. Preferably, the stand 16 is made of a vibration-damping material, such as rubber or other resilient material.

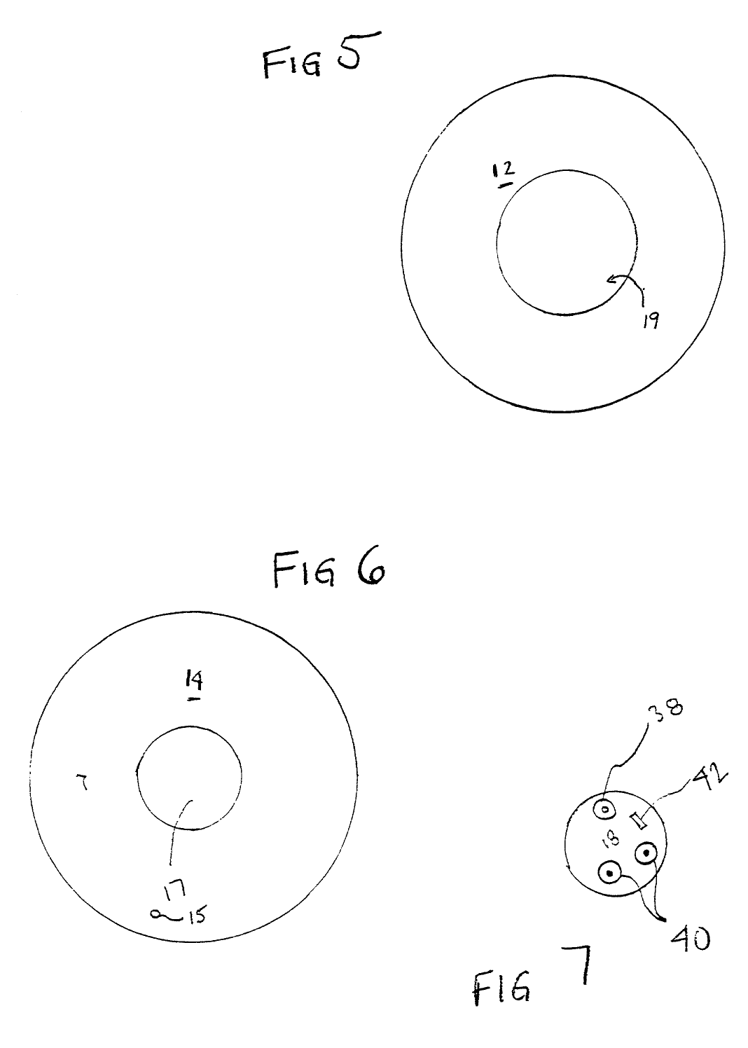

FIGS. 5 and 6 show isolated plan views of the first half 12, and the second half 14, respectively, each standing alone. Comparing FIGS. 5 and 6, note that the window 19 on the first half 12 is generally larger than the opening 17 on the second half 14. Of course, this size differential is not required. Additionally, the halves 12, 14 are shown to be generally round; however, this is also not required. However, it is preferred that the rims 22, 24 be formed of the same general shape—in this depicted instance, circular—so that they can tightly engage one another to from a perimeter.

Experimentation has found that inner surfaces of the halves be formed to be generally paraboloid in shape, in order to provide the best reverberation within the hollow chamber 36. Thus, while the inner contour preferably bears a general parabolic cross-section, the outer surface may be conceivably, other alternative shapes. The inner chamber 36 should be bound by a highly reflective acoustic material, such as a metal or ceramic. However, in order to selectively alter the acoustical quality of the apparatus 10, differing materials may be used, of course.

FIG. 7 shows the grille 18 having at least one tweeter 38 and at least one cross-over component 40 attached thereto. A battery 42 may be provided on the grille 18 in order to provide current to operate the tweeters 38 and cross-over component 40.

FIG. 8 details a preferred embodiment of the way the rims 22,24 lock together with a lock 46. Alternatively, the apparatus 10 may be equipped with a lock, strap, a snap-fit arrangement, or any means or mechanism to keep the rims 22,24 tightly engaged with one another.

Although the present invention has been described and illustrated in detail, it is to be clearly understood that the same is by way of illustration and example only, and is not to be taken by way of limitation. The spirit and scope of the present invention are to be limited only by the terms of the appended claims.

I claim:

1. A speaker apparatus, comprising:
a first general paraboloid-shaped half having a rim;
a second general paraboloid-shaped half having a rim;
a first opening positioned near a vertex of the first half;
a second opening positioned near a vertex of the second half;
a mid-range component positioned within the first opening;
at least one tweeter and at least one cross-over component coupled to a grille that is positioned within the second opening, wherein,
the respective rims of the first and second halves engage one another to form a generally hollow chamber therebetween.

2. The speaker apparatus of claim 1, further comprising vibration damper positioned between a perimeter of the grille and an edge of the second opening.

3 The speaker apparatus of claim 1, further comprising a vibration damper positioned between a perimeter of the mid-range component and an edge of the first opening.

4. The speaker apparatus of claim 1, further comprising a stand having a first end coupled to one of the first or second halves at a location adjacent its respective rim.

5. The speaker apparatus of claim 4, wherein the stand and the rims both engage a horizontal surface, thereby forming a base for the apparatus.

6. The speaker apparatus of claim 4, further comprising a node extending from on the stand adjacent its first end, whereby the stand, the rim, and the node cooperate to form a base for the apparatus to rest on a horizontal surface.

7. The speaker apparatus of claim 1, further comprising an actuator in communication with the at least one tweeter and the at least one cross-over component.

8. The speaker apparatus of claim 7, wherein the actuator further comprises at least one of volume controls, bass control, or treble control.

9. The speaker apparatus of claim 1, wherein the at least one tweeter and the at least one cross-over component are configured to face the hollow chamber, and the mid-range component is positioned to face away from the hollow chamber.

10. The speaker apparatus of claim 1, wherein the halves are metal.

11. The speaker apparatus of claim 1, further comprising a lock on the rim of at least one of the halves, the lock configured to keep the halves together.

13. The speaker apparatus of claim 1, further comprising a power source.

14. The speaker apparatus of claim 13, wherein the power source is a battery.

15. The speaker apparatus of claim 13, wherein the power source is an electrical plug for connection to an outlet.

16. The speaker apparatus of claim 15, further comprising an electrical receptacle positioned on an outer surface of one of the first or second halves.

17. The speaker apparatus of claim 1, wherein each of the first and second openings is circular.

18. The speaker apparatus of claim 17, wherein the second opening is smaller than the first opening.

19. A speaker apparatus, comprising:
a first bowl-shaped half having a rim;
a second bowl-shaped half having a rim;
a generally hollow chamber formed between the halves as their respective rims are joined together, thereby forming a perimeter at the joined rims;
a window generally centrally positioned in the first half;
an opening generally centrally positioned in the second half,
a grille positioned within the opening;
at least one tweeter and at least one cross-over component, each coupled to the grille, and,
a stand coupled to an outer surface of the apparatus and adjacent the perimeter, wherein
the stand is positioned generally parallel to a tangent of the perimeter, such that the stand and perimeter from a base when the apparatus is placed on a horizontal surface.

20. The speaker apparatus of claim 19, further comprising a lock on the rim of at least one of the halves, the lock configured to keep the halves together.

21. The speaker apparatus of claim 19, further comprising an actuator in communication with the at least one tweeter and the at least one cross-over component.

22. The speaker apparatus of claim 21, wherein the actuator further comprises at least one of volume controls, bass control, or treble control, or a graphic equalizer.

23. The speaker apparatus of claim 19, wherein the halves are metal.

24. The speaker apparatus of claim 19, further comprising a vibration damper positioned between an edge of the grille and an edge of the opening.

25. The speaker apparatus of claim 19, further comprising a mid-range component positioned within the window.

26. The speaker apparatus of claim 25, further comprising a vibration damper positioned between an edge of the mid-range component and an edge of the opening.

28. The speaker apparatus of claim 19, wherein the stand comprises a first end coupled to the apparatus, and includes a node positioned near the first end, wherein the stand, perimeter, and node cooperate to form a base for the apparatus when placed on a horizontal surface.

29. The speaker apparatus of claim 19, wherein the opening is circular.

30. The speaker apparatus of claim 19, wherein the window is round.

31. The speaker apparatus of claim 19, wherein the opening is smaller than the window.
